(19) United States
(12) Patent Application Publication
(10) Pub. No.: US 2026/0027457 A1
(43) Pub. Date: Jan. 29, 2026

(54) Matching Users for a Shared Virtual Experience Through Virtual Objects with Multiple Simultaneous Geolocations

(71) Applicant: Niantic, Inc., San Francisco, CA (US)

(72) Inventors: Chihiro Kanno, Kawasaki-shi (JP); Daigo Moriwaki, Tokyo (JP); Hiroki Asakawa, Tokyo (JP); Tatsuo Nomura, Singapore (SG)

(21) Appl. No.: 19/217,042

(22) Filed: May 23, 2025

Related U.S. Application Data
(60) Provisional application No. 63/674,694, filed on Jul. 23, 2024.

(51) Int. Cl. A63F 13/35; A63F 13/216; A63F 13/52; A63F 13/795

(52) U.S. Cl. CPC A63F 13/35; A63F 13/216; A63F 13/52; A63F 13/795; A63F 2300/205; A63F 2300/5566; A63F 2300/8082

(57) ABSTRACT

A server hosts shared virtual experiences between users. The server receives, from a first client device of a first user, a request to participate in a shared virtual experience. The request includes an object identifier associated with initializing the shared virtual experience. The server matches the first user to one or more other users to form a group based on the object identifier. The object identifier may be a virtual object with representations dispersed across real-world locations. The object identifier may be a point of interest. Once matched, the server provides the shared virtual experience to the users in the group. Providing the shared virtual experience entails causing an electronic display of the client devices to display a tailored perspective of the shared virtual experience comprising shared content common to all users of the group participating in the shared virtual experience and player-specific content specific to each user.

### CROSS-REFERENCE TO RELATED APPLICATION

This application claims the benefit of U.S. Provisional Application No. 63/674,694, filed on Jul. 23, 2024, which is incorporated by reference.

### BACKGROUND

### 1. Technical Field

The subject matter described relates generally to parallel-reality applications, and, in particular, to parallel-reality applications in which interactable virtual elements can have multiple real-world locations.

### 2. Problem

In parallel reality applications, virtual objects are mapped to locations in the real world such that users can interact with the virtual objects (e.g., via a smartphone) by traveling to the corresponding real-world locations. Many parallel-reality applications provide virtual experiences in which multiple users can collaborate in interactions with virtual objects. For example, players of a monster hunting game may team up to fight a particularly challenging monster. Conventionally, users that are in the same geographic location interact with the same virtual element to trigger a shared virtual experience. However, this can present problems for users in geographic areas with low numbers of users (e.g., rural areas) as they may be unable to find other users with which to collaborate.

### SUMMARY

The present disclosure describes various approaches for providing shared virtual experiences between users in a parallel-reality application. In one embodiment, a virtual object having an object identifier is represented by multiple visual representations that appear to users at different real-world locations. When a user interacts with one of the visual representations on their client device, a request including the object identifier may be sent to a server. The server may query a database using the object identifier for shared virtual experiences involving the virtual object. The server may assign the user to a shared virtual experience identified by the query and cause the user's client device to provide the assigned shared virtual experience. The virtual experience may be shared with users who initiated the shared virtual experience by interacting with one or more other ones of the visual representations. Thus, users from vastly different locations may share the virtual experience. For example, one player in Japan and another player in the United States may team up to fight a monster in a parallel-reality game.

### BRIEF DESCRIPTION OF THE DRAWINGS

FIG. 1 depicts a representation of a virtual world having a geography that parallels the real world, according to one or more embodiments.

FIG. 2 depicts an exemplary interface of a parallel reality game, according to one or more embodiments.

FIG. 3 is a block diagram of a networked computing environment suitable for providing shared virtual experiences to geographically diverse users, according to one or more embodiments.

FIG. 4 illustrates a process of pairing users based on interactions with multiple visual representations of a virtual object, according to one or more embodiments.

FIG. 5 illustrates an iterative process of expanding a geographic search area for identifying users to pair, according to one or more embodiments.

FIG. 6 illustrates a range of S2 cells considered in the iterative process of FIG. 5, according to one or more embodiments.

FIG. 7 is a flowchart describing a matching process for a shared virtual experience, according to one or more embodiments.

FIG. 8 illustrates an example computer system suitable for use in the networked computing environment of FIG. 1, according to one or more embodiments.

### DETAILED DESCRIPTION

The figures and the following description describe certain embodiments by way of illustration only. One skilled in the art will recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

Various embodiments are described in the context of a parallel reality game that includes augmented reality content in a virtual world geography that parallels at least a portion of the real-world geography such that player movement and actions in the real-world affect actions in the virtual world. The subject matter described is applicable in other situations in which providing shared virtual experiences to geographically separated users is desirable. In addition, the inherent flexibility of computer-based systems allows for a great variety of possible configurations, combinations, and divisions of tasks and functionality between and among the components of the system.

### Example Location-Based Parallel Reality Game

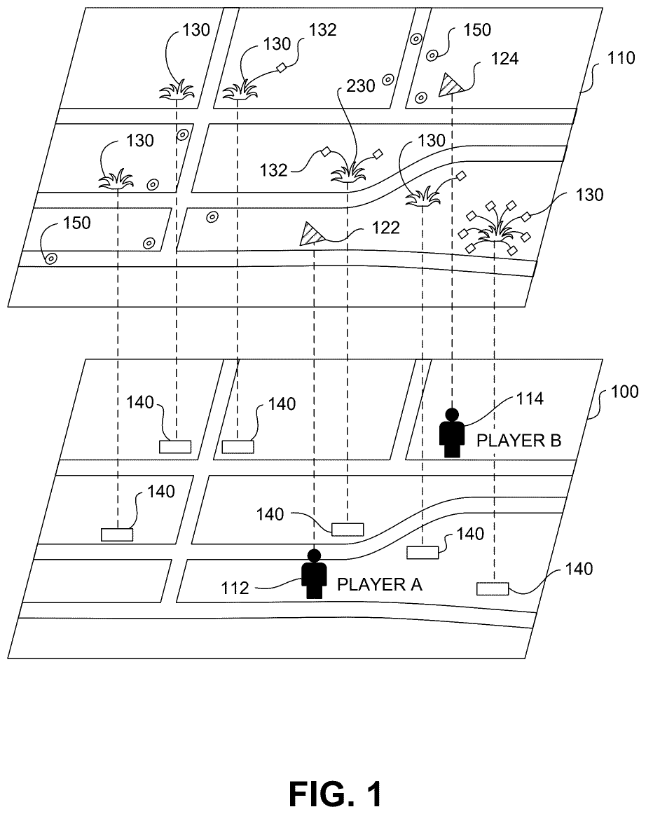

FIG. 1 is a conceptual diagram of a virtual world 110 that parallels the real world 100. The virtual world 110 can act as the game board for players of a parallel reality game. As illustrated, the virtual world 110 includes a geography that parallels the geography of the real world 100. In particular, a range of coordinates defining a geographic area or space in the real world 100 is mapped to a corresponding range of coordinates defining a virtual space in the virtual world 110. The range of coordinates in the real world 100 can be associated with a town, neighborhood, city, campus, locale, a country, continent, the entire globe, or other geographic area. Each geographic coordinate in the range of geographic coordinates is mapped to a corresponding coordinate in a virtual space in the virtual world 110.

A player's position in the virtual world 110 corresponds to the player's position in the real world 100. For instance, player A located at position 112 in the real world 100 has a corresponding position 122 in the virtual world 110. Similarly, player B located at position 114 in the real world 100 has a corresponding position 124 in the virtual world 110. As the players move about in a range of geographic coordinates in the real world 100, the players also move about in the range of coordinates defining the virtual space in the virtual world 110. In particular, a positioning system (e.g., a GPS system, a localization system, or both) associated with a mobile computing device carried by the player can be used to track a player's position as the player navigates the range of geographic coordinates in the real world 100. Data associated with the player's position in the real world 100 is used to update the player's position in the corresponding range of coordinates defining the virtual space in the virtual world 110. In this manner, players can navigate along a continuous track in the range of coordinates defining the virtual space in the virtual world 110 by simply traveling among the corresponding range of geographic coordinates in the real world 100 without having to check in or periodically update location information at specific discrete locations in the real world 100.

The location-based game can include game objectives requiring players to travel to or interact with various virtual elements or virtual objects scattered at various virtual locations in the virtual world 110. A player can travel to these virtual locations by traveling to the corresponding location of the virtual elements or objects in the real world 100. For instance, a positioning system can track the position of the player such that as the player navigates the real world 100, the player also navigates the parallel virtual world 110. The player can then interact with various virtual elements and objects at the specific location to achieve or perform one or more game objectives.

A game objective may have players interacting with virtual elements 130 located at various virtual locations in the virtual world 110. These virtual elements 130 can be linked to landmarks, geographic locations, or objects 140 in the real world 100. The real-world landmarks or objects 140 can be works of art, monuments, buildings, businesses, libraries, museums, or other suitable real-world landmarks or objects. Interactions include capturing, claiming ownership of, using some virtual item, spending some virtual currency, etc. To capture these virtual elements 130, a player travels to the landmark or geographic locations 140 linked to the virtual elements 130 in the real world and performs any necessary interactions (as defined by the game's rules) with the virtual elements 130 in the virtual world 110. For example, player A may have to travel to a landmark 140 in the real world 100 to interact with or capture a virtual element 130 linked with that particular landmark 140. The interaction with the virtual element 130 can require action in the real world, such as taking a photograph or verifying, obtaining, or capturing other information about the landmark or object 140 associated with the virtual element 130.

Game objectives may require that players use one or more virtual items that are collected by the players in the location-based game. For instance, the players may travel the virtual world 110 seeking virtual items 132 (e.g., weapons, creatures, power ups, or other items) that can be useful for completing game objectives. These virtual items 132 can be found or collected by traveling to different locations in the real world 100 or by completing various actions in either the virtual world 110 or the real world 100 (such as interacting with virtual elements 130, battling non-player characters or other players, or completing quests, etc.). In the example shown in FIG. 1, a player uses virtual items 132 to capture one or more virtual elements 130. In particular, a player can deploy virtual items 132 at locations in the virtual world 110 near to or within the virtual elements 130. Deploying one or more virtual items 132 in this manner can result in the capture of the virtual element 130 for the player or for the team/faction of the player.

In one particular implementation, a player may have to gather virtual energy as part of the parallel reality game. Virtual energy 150 can be scattered at different locations in the virtual world 110. A player can collect the virtual energy 150 by traveling to (or within a threshold distance of) the location in the real world 100 that corresponds to the location of the virtual energy in the virtual world 110. The virtual energy 150 can be used to power virtual items or perform various game objectives in the game. A player that loses all virtual energy 150 may be disconnected from the game or prevented from playing for a certain amount of time or until they have collected additional virtual energy 150.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing their locations.

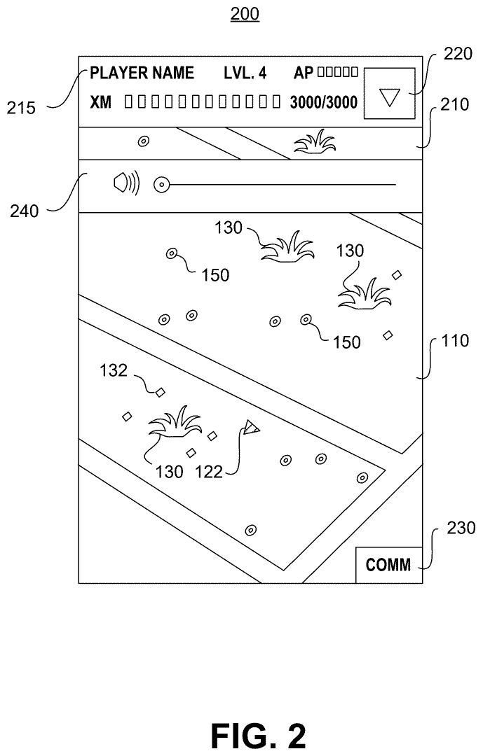

FIG. 2 depicts one embodiment of a game interface 200 that can be presented (e.g., on a player's smartphone) as part of the interface between the player and the virtual world 110. The game interface 200 includes a display window 210 that can be used to display the virtual world 110 and various other aspects of the game, such as player position 122 and the locations of virtual elements 130, virtual items 132, and virtual energy 150 in the virtual world 110. The user interface 200 can also display other information, such as game data information, game communications, player information, client location verification instructions and other information associated with the game. For example, the user interface can display player information 215, such as player name, experience level, and other information. The user interface 200 can include a menu 220 for accessing various game settings and other information associated with the game. The user interface 200 can also include a communications interface 230 that enables communications between the game system and the player and between one or more players of the parallel reality game.

According to aspects of the present disclosure, a player can interact with the parallel reality game by carrying a client device around in the real world. For instance, a player can play the game by accessing an application associated with the parallel reality game on a smartphone and moving about in the real world with the smartphone. In this regard, it is not necessary for the player to continuously view a visual representation of the virtual world on a display screen in order to play the location-based game. As a result, the user interface 200 can include non-visual elements that allow a user to interact with the game. For instance, the game interface can provide audible notifications to the player when the player is approaching a virtual element or object in the game or when an important event happens in the parallel reality game. In some embodiments, a player can control these audible notifications with audio control 240. Different types of audible notifications can be provided to the user depending on the type of virtual element or event. The audible notification can increase or decrease in frequency or volume depending on a player's proximity to a virtual element or object. Other non-visual notifications and signals can be provided to the user, such as a vibratory notification or other suitable notifications or signals.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. Players may also be able to obtain enhanced “powers” or virtual items that can be used to complete game objectives within the game.

In one or more embodiments, the parallel reality game may host a shared virtual experience with two or more client devices associated with two or more different players of the parallel reality game. The shared virtual experience may link players from different geographical regions in the world. To join the shared virtual experience, the players may provide a request to the join the shared virtual experience. In some embodiments, the parallel reality game may spawn a plurality of virtual elements in different geographical regions in the world. To request to join the shared virtual experience, a player interacts with the virtual element in their vicinity (e.g., clicks or taps on the virtual element, exchanges some in-game tokens, etc.). The virtual elements may be a portal, a character, a landmark, an object, or some other element in the parallel reality game. In other embodiments, the parallel reality game may provide an option to request to join the shared virtual experience based on the player's real-world location or the player's actions. For example, as the player approaches a point of interest (in the real-world), the parallel reality game may provide the option to request to the join the shared virtual experience. The player may accept the option, thereby requesting to join the shared virtual experience.

The parallel reality game groups players together to participate in the shared virtual experience. When grouping players together, the parallel reality game may implement a heuristics approach. For example, the parallel reality game may group players based on time in queue, position in queue, geographical location, geographical region, point of interest, lobby wait times, player statistics, etc. For example, the parallel reality game may prioritize grouping players from different geographical regions together. In another example, the parallel reality game may prioritize grouping players from a similar geographical region together. In one example, once a minimum number of players are slotted into a lobby, a time limit is placed on duration of the lobby. Others may be slotted in during that time limit (e.g., up to the maximum player limit), or, the time limit may expire, and the lobby initiates the shared virtual experience.

When in the shared virtual experience, the parallel reality game may tailor presentation to each player. Players in the same experience may be in different geographical regions of the world. For example, one player may be in one country with another player in another country. The parallel reality game may present virtual elements shared across all players in the lobby. For example, in a monster hunting context, all players in one lobby see the same monster being hunted. All players can also see avatars of the other players in their lobby. In another example, the monster being hunted is shared content, such that actions by one player that affect the monster are presented to other players in the lobby. The parallel reality game may also present player-specific content. In one or more embodiments, the parallel reality game may render the background based on the player's geographical position. For example, a portion of the virtual world corresponding to the player's geographical position is rendered in the background to the virtual elements shared across players in the lobby. As such, the background for each player is specific to that player. In other embodiments, other content that is player-specific may be presented in conjunction with the shared content across players in the lobby. By combining player-specific content and shared content, players can engage in these shared virtual experiences with tailored perspectives from their client devices. This tailored rendering of content per player, i.e., the combination of player-specific content and shared content, yields a technical improvement in parallel reality gaming.

Those of ordinary skill in the art, using the disclosures provided, will appreciate that numerous game interface configurations and underlying functionalities are possible. The present disclosure is not intended to be limited to any one particular configuration unless it is explicitly stated to the contrary.

### Example Gaming System

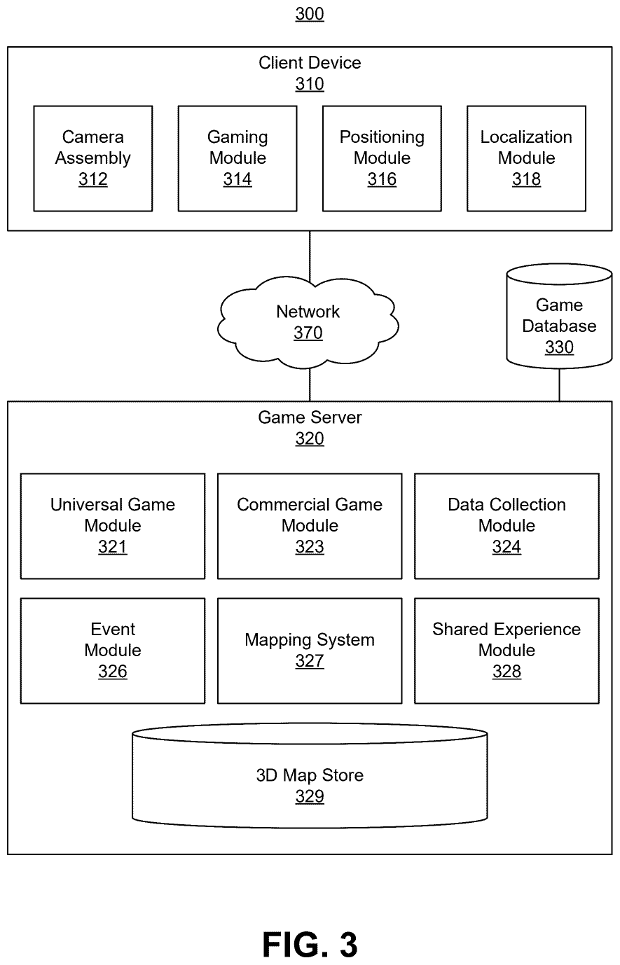

FIG. 3 illustrates one embodiment of a networked computing environment 300. The networked computing environment 300 uses a client-server architecture, where a game server 320 communicates with a client device 310 over a network 370 to provide a parallel reality game to a player at the client device 310. The networked computing environment 300 also may include other external systems such as sponsor/advertiser systems or business systems. Although only one client device 310 is shown in FIG. 3, any number of client devices 310 or other external systems may be connected to the game server 320 over the network 370. Furthermore, the networked computing environment 300 may contain different or additional elements and functionality may be distributed between the client device 310 and the server 320 in different manners than described below.

The networked computing environment 300 provides for the interaction of players in a virtual world having a geography that parallels the real world. In particular, a geographic area in the real world can be linked or mapped directly to a corresponding area in the virtual world. A player can move about in the virtual world by moving to various geographic locations in the real world. For instance, a player's position in the real world can be tracked and used to update the player's position in the virtual world. Typically, the player's position in the real world is determined by finding the location of a client device 310 through which the player is interacting with the virtual world and assuming the player is at the same (or approximately the same) location. For example, in various embodiments, the player may interact with a virtual element if the player's location in the real world is within a threshold distance (e.g., ten meters, twenty meters, etc.) of the real-world location that corresponds to the virtual location of the virtual element in the virtual world. For convenience, various embodiments are described with reference to “the player's location” but one of skill in the art will appreciate that such references may refer to the location of the player's client device 310.

A client device 310 can be any portable computing device capable for use by a player to interface with the game server 320. For instance, a client device 310 is preferably a portable wireless device that can be carried by a player, such as a smartphone, portable gaming device, augmented reality (AR) headset, cellular phone, tablet, personal digital assistant (PDA), navigation system, handheld GPS system, or other such device. For some use cases, the client device 310 may be a less-mobile device such as a desktop or a laptop computer. Furthermore, the client device 310 may be a vehicle with a built-in computing device.

The client device 310 communicates with the game server 320 to provide sensory data of a physical environment. In one embodiment, the client device 310 includes a camera assembly 312, a gaming module 314, a positioning module 316, and a localization module 318. The client device 310 also includes a network interface (not shown) for providing communications over the network 370. In various embodiments, the client device 310 may include different or additional components, such as additional sensors, display, and software modules, etc.

The camera assembly 312 includes one or more cameras which can capture image data. The cameras capture image data describing a scene of the environment surrounding the client device 310 with a particular pose (the location and orientation of the camera within the environment). The camera assembly 312 may use a variety of photo sensors with varying color capture ranges and varying capture rates. Similarly, the camera assembly 312 may include cameras with a range of different lenses, such as a wide-angle lens or a telephoto lens. The camera assembly 312 may be configured to capture single images or multiple images as frames of a video.

The client device 310 may also include additional sensors for collecting data regarding the environment surrounding the client device, such as movement sensors, accelerometers, gyroscopes, barometers, thermometers, light sensors, microphones, etc. The image data captured by the camera assembly 312 can be appended with metadata describing other information about the image data, such as additional sensory data (e.g., temperature, brightness of environment, air pressure, location, pose etc.) or capture data (e.g., exposure length, shutter speed, focal length, capture time, etc.).

The gaming module 314 provides a player with an interface to participate in the parallel reality game. The game server 320 transmits game data over the network 370 to the client device 310 for use by the gaming module 314 to provide a local version of the game to a player at locations remote from the game server. In one embodiment, the gaming module 314 presents a user interface on a display of the client device 310 that depicts a virtual world (e.g., renders imagery of the virtual world) and allows a user to interact with the virtual world to perform various game objectives. In some embodiments, the gaming module 314 presents images of the real world (e.g., captured by the camera assembly 312) augmented with virtual elements from the parallel reality game. In these embodiments, the gaming module 314 may generate or adjust virtual content according to other information received from other components of the client device 310. For example, the gaming module 314 may adjust a virtual object to be displayed on the user interface according to a depth map of the scene captured in the image data.

The gaming module 314 can also control various other outputs to allow a player to interact with the game without requiring the player to view a display screen. For instance, the gaming module 314 can control various audio, vibratory, or other notifications that allow the player to play the game without looking at the display screen.

The positioning module 316 can be any device or circuitry for determining the position of the client device 310. For example, the positioning module 316 can determine actual or relative position by using a satellite navigation positioning system (e.g., a GPS system, a Galileo positioning system, the Global Navigation satellite system (GLONASS), the BeiDou Satellite Navigation and Positioning system), an inertial navigation system, a dead reckoning system, IP address analysis, triangulation or proximity to cellular towers or Wi-Fi hotspots, or other suitable techniques.

As the player moves around with the client device 310 in the real world, the positioning module 316 tracks the position of the player and provides the player position information to the gaming module 314. The gaming module 314 updates the player position in the virtual world associated with the game based on the actual position of the player in the real world. Thus, a player can interact with the virtual world simply by carrying or transporting the client device 310 in the real world. In particular, the location of the player in the virtual world can correspond to the location of the player in the real world. The gaming module 314 can provide player position information to the game server 320 over the network 370. In response, the game server 320 may enact various techniques to verify the location of the client device 310 to prevent cheaters from spoofing their locations. It should be understood that location information associated with a player is utilized only if permission is granted after the player has been notified that location information of the player is to be accessed and how the location information is to be utilized in the context of the game (e.g., to update player position in the virtual world). In addition, any location information associated with players is stored and maintained in a manner to protect player privacy.

The localization module 318 provides an additional or alternative way to determine the location of the client device 310. In one embodiment, the localization module 318 receives the location determined for the client device 310 by the positioning module 316 and refines it by determining a pose of one or more cameras of the camera assembly 312. The localization module 318 may use the location generated by the positioning module 316 to select a 3D map of the environment surrounding the client device 310 and localize against the 3D map. The localization module 318 may obtain the 3D map from local storage or from the game server 320. The 3D map may be a point cloud, mesh, or any other suitable 3D representation of the environment surrounding the client device 310. Alternatively, the localization module 318 may determine a location or pose of the client device 310 without reference to a coarse location (such as one provided by a GPS system), such as by determining the relative location of the client device 310 to another device.

In one embodiment, the localization module 318 applies a trained model to determine the pose of images captured by the camera assembly 312 relative to the 3D map. Thus, the localization model can determine an accurate (e.g., to within a few centimeters and degrees) determination of the position and orientation of the client device 310. The position of the client device 310 can then be tracked over time using dead reckoning based on sensor readings, periodic re-localization, or a combination of both. Having an accurate pose for the client device 310 may enable the gaming module 314 to present virtual content overlaid on images of the real world (e.g., by displaying virtual elements in conjunction with a real-time feed from the camera assembly 312 on a display) or the real world itself (e.g., by displaying virtual elements on a transparent display of an AR headset) in a manner that gives the impression that the virtual objects are interacting with the real world. For example, a virtual character may hide behind a real tree, a virtual hat may be placed on a real statue, or a virtual creature may run and hide if a real person approaches it too quickly.

The game server 320 includes one or more computing devices that provide game functionality to the client device 310. The game server 320 can include or be in communication with a game database 330. The game database 330 stores game data used in the parallel reality game to be served or provided to the client device 310 over the network 370.

The game data stored in the game database 330 can include: (1) data associated with the virtual world in the parallel reality game (e.g., image data used to render the virtual world on a display device, geographic coordinates of locations in the virtual world, etc.); (2) data associated with players of the parallel reality game (e.g., player profiles including but not limited to player information, player experience level, player currency, current player positions in the virtual world/real world, player energy level, player preferences, team information, faction information, etc.); (3) data associated with game objectives (e.g., data associated with current game objectives, status of game objectives, past game objectives, future game objectives, desired game objectives, etc.); (4) data associated with virtual elements in the virtual world (e.g., positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g., location of real-world objects/landmarks, description of real-world objects/landmarks, relevance of virtual elements linked to real-world objects, etc.); (6) game status (e.g., current number of players, current status of game objectives, player leaderboard, etc.); (7) data associated with player actions/input (e.g., current player positions, past player positions, player moves, player input, player queries, player communications, etc.); or (8) any other data used, related to, or obtained during implementation of the parallel reality game. The game data stored in the game database 330 can be populated either offline or in real time by system administrators or by data received from users (e.g., players), such as from a client device 310 over the network 370.

In one embodiment, the game server 320 is configured to receive requests for game data from a client device 310 (for instance via remote procedure calls (RPCs)) and to respond to those requests via the network 370. The game server 320 can encode game data in one or more data files and provide the data files to the client device 310. In addition, the game server 320 can be configured to receive game data (e.g., player positions, player actions, player input, etc.) from a client device 310 via the network 370. The client device 310 can be configured to periodically send player input and other updates to the game server 320, which the game server uses to update game data in the game database 330 to reflect any and all changed conditions for the game.

In the embodiment shown in FIG. 3, the game server 320 includes a universal game module 321, a commercial game module 323, a data collection module 324, an event module 326, a mapping system 327, a shared experience module 380, and a 3D map store 329. As mentioned above, the game server 320 interacts with a game database 330 that may be part of the game server or accessed remotely (e.g., the game database 330 may be a distributed database accessed via the network 370). In other embodiments, the game server 320 contains different or additional elements. In addition, the functions may be distributed among the elements in a different manner than described.

The universal game module 322 hosts an instance of the parallel reality game for a set of players (e.g., all players of the parallel reality game) and acts as the authoritative source for the current status of the parallel reality game for the set of players. As the host, the universal game module 322 generates game content for presentation to players (e.g., via their respective client devices 310). The universal game module 322 may access the game database 330 to retrieve or store game data when hosting the parallel reality game. The universal game module 322 may also receive game data from client devices 310 (e.g., depth information, player input, player position, player actions, landmark information, etc.) and incorporates the game data received into the overall parallel reality game for the entire set of players of the parallel reality game. The universal game module 322 can also manage the delivery of game data to the client device 310 over the network 370. In some embodiments, the universal game module 322 also governs security aspects of the interaction of the client device 310 with the parallel reality game, such as securing connections between the client device and the game server 320, establishing connections between various client devices, or verifying the location of the various client devices 310 to prevent players cheating by spoofing their location.

The commercial game module 323 can be separate from or a part of the universal game module 322. The commercial game module 323 can manage the inclusion of various game features within the parallel reality game that are linked with a commercial activity in the real world. For instance, the commercial game module 323 can receive requests from external systems such as sponsors/advertisers, businesses, or other entities over the network 370 to include game features linked with commercial activity in the real world. The commercial game module 323 can then arrange for the inclusion of these game features in the parallel reality game on confirming the linked commercial activity has occurred. For example, if a business pays the provider of the parallel reality game an agreed upon amount, a virtual object identifying the business may appear in the parallel reality game at a virtual location corresponding to a real-world location of the business (e.g., a store or restaurant).

The data collection module 324 can be separate from or a part of the universal game module 322. The data collection module 324 can manage the inclusion of various game features within the parallel reality game that are linked with a data collection activity in the real world. For instance, the data collection module 324 can modify game data stored in the game database 330 to include game features linked with data collection activity in the parallel reality game. The data collection module 324 can also analyze data collected by players pursuant to the data collection activity and provide the data for access by various platforms.

The event module 326 manages player access to events in the parallel reality game. Although the term “event” is used for convenience, it should be appreciated that this term need not refer to a specific event at a specific location or time. Rather, it may refer to any provision of access-controlled game content where one or more access criteria are used to determine whether players may access that content. Such content may be part of a larger parallel reality game that includes game content with less or no access control or may be a stand-alone, access controlled parallel reality game. For example, the event module 326 may present content for a shared virtual experience between multiple players in the parallel reality game.

The mapping system 327 generates a 3D map of a geographical region based on a set of images. The 3D map may be a point cloud, polygon mesh, or any other suitable representation of the 3D geometry of the geographical region. The 3D map may include semantic labels providing additional contextual information, such as identifying objects tables, chairs, clocks, lampposts, trees, etc.), materials (concrete, water, brick, grass, etc.), or game properties (e.g., traversable by characters, suitable for certain in-game actions, etc.). In one embodiment, the mapping system 327 stores the 3D map along with any semantic/contextual information in the 3D map store 329. The 3D map may be stored in the 3D map store 329 in conjunction with location information (e.g., GPS coordinates of the center of the 3D map, a ringfence defining the extent of the 3D map, or the like). Thus, the game server 320 can provide the 3D map to client devices 310 that provide location data indicating they are within or near the geographic area covered by the 3D map.

The shared experience module 328 identifies groups of two or more players to participate in shared virtual experiences. In one embodiment, the shared virtual experience module 328 defines a virtual object (e.g., a monster) that has an object ID and identifies two or more locations in the virtual world at which to place visual representations of the virtual object. Thus, users that are located at or near the real-world location corresponding to one of the virtual locations can see one of the visual representations within the parallel-reality game on their client device.

If a player interacts with one of the visual representations (e.g., by clicking on tapping on it), their client device sends a request for a shared virtual experience to the shared experience module 328 via the network 370. The request may include the object ID for the virtual object and a player ID of the player. The shared experience module 328 may add the request to a list of such requests (e.g., in a database) and group the player with one or more players who also interacted with a visual representation of the virtual object recently (e.g., within the last two minutes).

In one embodiment, the shared experience module 328 initially tries to group players that interacted with the same visual representation of the virtual object. If after a predetermined amount of time (e.g., ten seconds), if a group having a minimum size (e.g., two players) has not been formed, the shared experience module 328 may try to group players that interacted with any one of the visual representations within a group. For example, the visual representations may be divided into a predetermined number of groups (e.g., 256 groups). This process may be iterated considering increasingly larger groups, ending by considering players who have interacted with any of the visual representations anywhere in the world until a group of the minimum size has been formed. Alternatively, the shared experience module 328 may continue to expand the scope of the search until a maximum sized group (e.g., four players) has been formed.

The shared experience module 328 may use various parameters to determine how to group players. For example, players may be divided into group of predetermined size (e.g., four) where possible, with how players are split between groups being decided by one or more factors, such as grouping players of similar experience or game levels, grouping players with similar interests indicated in a player profile, grouping players to maximize or minimize the distance between players in the groups, or grouping players who regularly play together or have added each other as contacts within the game, etc.

There may be other constraints in the matching process, e.g., minimum size limit, maximum size limit, maximum lobby waiting time duration, etc. In one or more embodiments, the shared experience module 328 may leverage a rule-based approach, progressing through one or more rules that guide the matching process. For example, one rule matches players in the same geographic region together. Another rule matches players in the queue, in a first-in-first-out fashion. Another rule matches players of similar skill. Another rule combines groups or lobbies that are partially filled. Another rule initiates the shared virtual experience once all players in the lobby provide indication that they are ready. Another rule initiates the shared virtual experience once a majority of players in the lobby provide indication that they are ready. Another rule initiates the shared virtual experience once a time limit expires.

The shared experience module 328 may then cause the client devices of grouped players to provide a shared virtual experience. For example, groups of players may battle a monster cooperatively, or battle each other, with in game rewards being provided based on performance within the shared virtual experience.

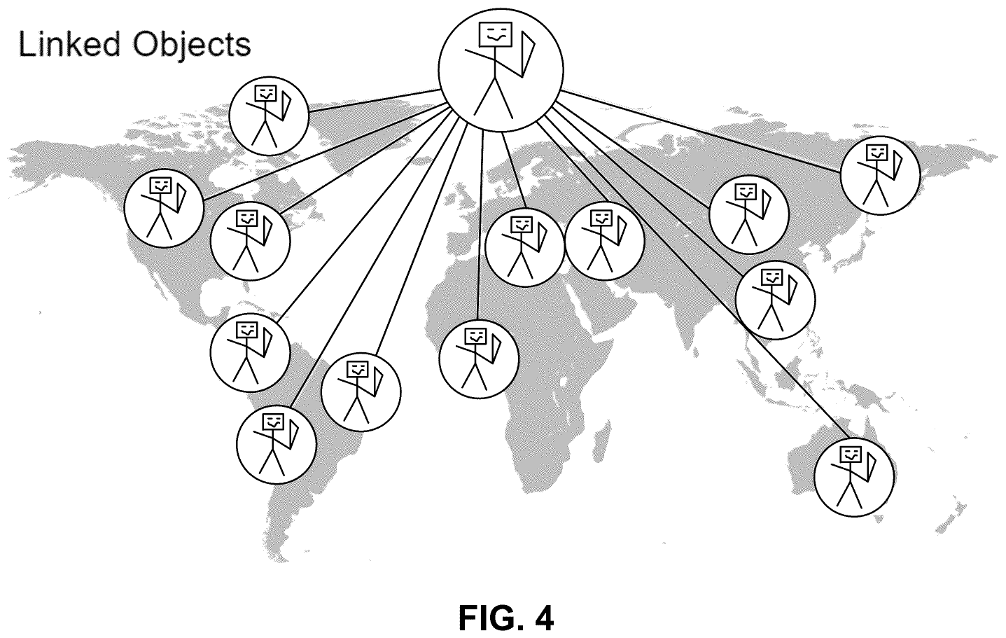

FIG. 4 illustrates an example of providing a shared virtual experience in which multiple players hunt a monster. A single monster has visual representations all over the world. Players that elect to hunt the monster by selecting any of the visual representations may be paired with players that interact with any of the other visual representations anywhere in the world. Interacting with the virtual representation of the monster (e.g., by clicking or tapping) provides a request to join a shared virtual experience, i.e., the player is in queue for matching to other players that have also requested to join the shared virtual experience. In this way, players that are physically separated by a large distance may have opportunities to play together, and players that are located in remote areas may still participate in shared virtual experiences without having to travel large distances to more densely populated areas.

In another embodiment, players may be grouped by initially attempting to group players that are located physically close together and iteratively expanding the range of search for matching players until a desired number of matches (e.g., four players) is found. Players may interact with a virtual object of a particular type to request a shared virtual experience. For example, points of interest (POIs) may host hunts for various types of monster and players may initiate a hunt for a particular monster type by interacting with a point of interest hosting a hunt for that monster type. A player initiating a shared virtual experience may be grouped with other players requesting the same type of shared virtual experience (e.g., initiating hunts for the same monster type) by a matching algorithm that iteratively considers players at increasingly greater distances from the player.

In one or more embodiments, when participating in the shared virtual experience, the parallel reality game presents tailored perspectives to each player participating. The parallel reality game presents shared content and player-specific content on each player's client device. The shared content may include the virtual representation of the monster, one or more avatars of other players participating in the shared virtual experience, actions by players in the shared virtual experience, or some combination thereof. The player-specific content is content that is rendered specifically to the player, e.g., which may be based on the player's geographical region, the player's geographical location, a time of day for the player, environmental factors for the player, etc. Tailoring the perspective of each player yields a technical improvement. Each player perceives the shared virtual experience is occurring in their locale, though, in actuality, the players grouped together in that shared virtual experience may be disparately located around the world and in different geographical regions.

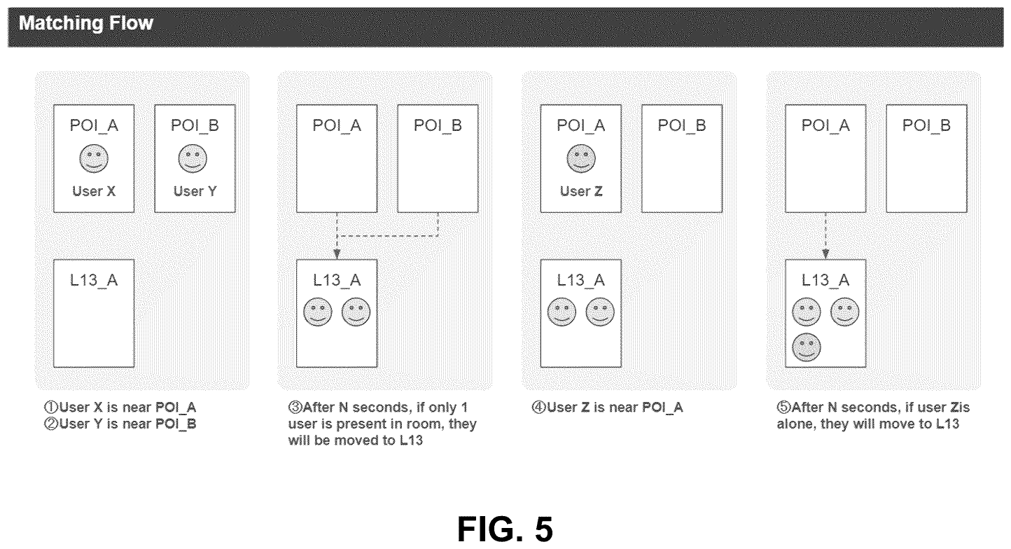

FIG. 5 illustrates an embodiment in which a player requests a shared virtual experience by interacting with a virtual object (e.g., a point of interest hosting a hunt). The shared experience module 328 receives location data for the player (e.g., coordinates of the virtual object with which they interacted to request the shared virtual experience) and searches for other players requesting a shared virtual experience within a geographic area at a first scale that includes the location of the player. In one embodiment, the shared experience module 328 initially searches for other players that requested a shared virtual experience by interacting with the same virtual object as the first player (e.g., players at the same point of interest). In another embodiment, the shared experience module 328 may search for other players within the same S2 cell of a specified level (e.g., level 14) as the player. In a further embodiment, the shared experience module 328 may search for other players within a predetermined distance of the first player (e.g., within 200 meters).

If the shared experience module 328 finds other players requesting a shared virtual experience within the geographic at the first scale, they may be added to a group together for the shared virtual experience. After a predetermined time (e.g., ten seconds), if the player is not in a group having a minimum size (e.g., two players), the shared experience module 328 may expand the search to a larger geographic area. Alternatively, the shared experience module 328 may expand the search area unless a maximum sized group (e.g., four players) has already been formed. The larger geographic area may encompass the original geographic area searched. In one embodiment, the shared experience module 328 expands the search to a predetermined group of virtual objects that includes the virtual object with which the first player interacted. For example, points of interest may be placed into predetermined groups (e.g., all points of interest may be divided into 16 groups). In another embodiment, the shared experience module 328 may attempt to match the player with other players in the same S2 cell at a higher level than the initial search (e.g., the player's level 13 S2 cell, which encompasses the initial level 14 S2 searched and three others). In a further embodiment, the shared experience module 328 may search for other players within a larger predetermined distance (e.g., within 400 meters), etc. In one or more embodiments, the matching process may adapt to parameters of pending lobbies. For example, based on the number of players waiting in the lobby, the shared experience module 328 may adapt the matching process to lower the time limit until startup of the shared virtual experience. In another example, upon achieving a minimum number of players, the shared experience module 328 may hold the search expansion to the current geographical region. In the example shown in FIG. 5, user X at POI A and user Y at POI B are not in the same level 14 cell so are not initially matched, but once the search is expanded to level 13 S2 cell, the two users are now in the same S2 cell and are paired for a shared virtual experience.

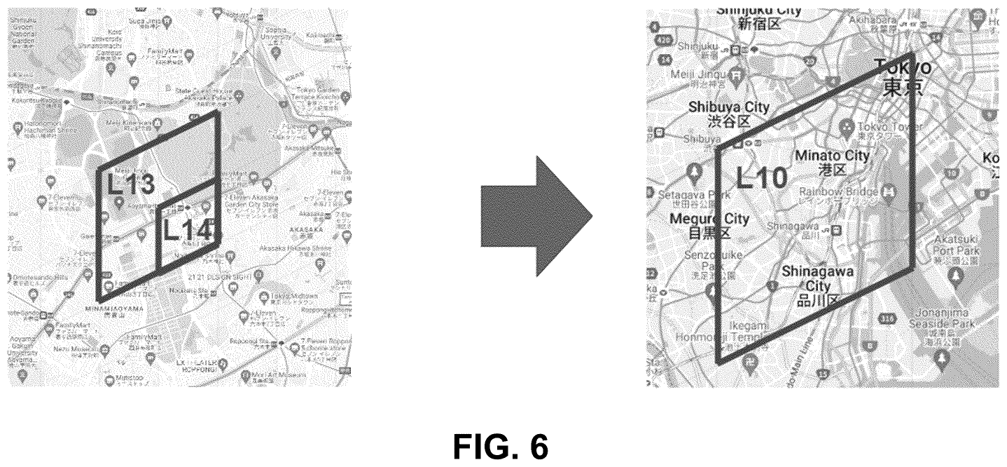

This process may iterate, increasing the search area each time until either a minimum size group has been formed or a maximum search area has been reached. In one embodiment, the process may end with a third scale of search that attempts to match the first player with other players anywhere in the world. In another embodiment, the maximum search area is the player's level 10 S2 cell. This is illustrated in FIG. 6, which shows various sizes of S2 cell in the vicinity of Tokyo, Japan.

Once the minimum sized group has been formed for the player making the initial request, the shared experience module 328 stops searching for additional players based on the initial request. In the example of FIG. 5, once users X and Y were paired (with a minimum group size of two), the shared experience module 328 stopped actively searching for additional users with which to pair user X (or user Y). However, users X and Y are placed in a lobby with a countdown for a predetermined time (e.g., for two minutes from user X's initial request, or one minute from when users X and Y were paired, etc.) During this time, the shared experience module 328 may add other users to the group based on requests for shared virtual experiences from those users. For example, as shown in FIG. 5, after users X and Y were paired, user Z that is in the same level 14 S2 cell as user X (near POI A) also requested a shared virtual experience. Assuming that user Z is not added to a level 14 S2 cell group (e.g., if user Z is playing with a group of friends that are traveling together who all request a shared virtual experience at the same POI), user Z is moved to the level 13 S2 cell search and the shared experience module 328 adds user Z to the level 13 S2 cell group with users X and Y.

The shared experience module 328 may add additional users to the group until the timer to the start of the shared virtual experience expires (or gets within a “last call” limit of the timer expiring, such as five seconds before the timer expires) or the group reaches a maximum size (e.g., four users). If an additional user requests a shared virtual experience in proximity to an existing group that is already full, the shared virtual experience module 328 may start a new group for that user and search for other users using the same process as was used for the group described above.

In one or more embodiments, when participating in the shared virtual experience, the parallel reality game presents tailored perspectives to each player participating. The parallel reality game presents shared content and player-specific content on each player's client device. The shared content may include one or more virtual representations of the in-game characters, one or more avatars of other players participating in the shared virtual experience, actions by players in the shared virtual experience, or some combination thereof. The player-specific content is content that is rendered specifically to the player, e.g., which may be based on the player's geographical region, the player's geographical location, a time of day for the player, environmental factors for the player, etc. Tailoring the perspective of each player yields a technical improvement. Each player perceives the shared virtual experience is occurring in their locale, though, in actuality, the players grouped together in that shared virtual experience may be disparately located around the world and in different geographical regions.

The network 370 can be any type of communications network, such as a local area network (e.g., an intranet), wide area network (e.g., the internet), or some combination thereof. The network can also include a direct connection between a client device 310 and the game server 320. In general, communication between the game server 320 and a client device 310 can be carried via a network interface using any type of wired or wireless connection, using a variety of communication protocols (e.g., TCP/IP, HTTP, SMTP, FTP), encodings or formats (e.g., HTML, XML, JSON), or protection schemes (e.g., VPN, secure HTTP, SSL).

This disclosure makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, processes disclosed as being implemented by a server may be implemented using a single server or multiple servers working in combination. Databases and applications may be implemented on a single system or distributed across multiple systems. Distributed components may operate sequentially or in parallel.

In situations in which the systems and methods disclosed access and analyze personal information about users, or make use of personal information, such as location information, the users may be provided with an opportunity to control whether programs or features collect the information and control whether or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

### Example Methods

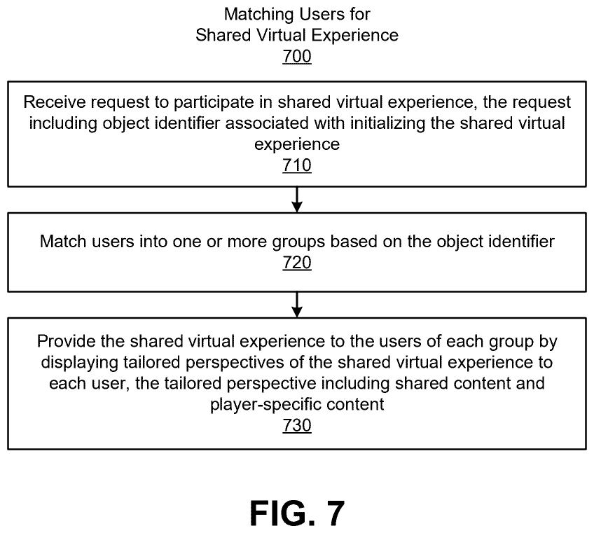

FIG. 7 is a flowchart describing a process 700 of matching users for a shared virtual experience, according to one or more embodiments. The process 700 may be performed by a game server (e.g., the game server 320 of FIG. 3). In other embodiments, the process 700 may be performed (partially or entirely) by another system or device. In other embodiments, the process 700 may include additional, fewer, or different steps than those listed herein.

The server receives 710 one or more requests to participate in a shared virtual experience. The request includes an object identifier associated with initializing the shared virtual experience. In some embodiments, the object identifier identifies a point of interest. The point of interest can be a real-world landmark or object, or a virtual object placed in the virtual world. Receiving the request may include determining that a geographical location of the client device (providing the request) is within a threshold proximity to the point of interest. In some embodiments, the object identifier identifies a virtual object that is represented by a plurality of visual representations viewable by users at a plurality of real-world locations. Receiving the request may entail receiving interaction by the user via their client device with one visual representation of the virtual object.

The server matches 720 users to form one or more groups based on the object identifier to participate in the shared virtual experience. The server may establish a list of users that have requested to participate in the shared virtual experience. From the list, the server may group users together. In some embodiments, the matching may entail expanding searches for users based on a geographical location of the point of interest. In such embodiments, the server performs a first search of a first geographic area including the point of interest at a first scale to identify users that may be suitable for grouping. If such users are identified, the server forms a group and may progress the group towards initializing the shared virtual experience. If the server does not identify sufficient suitable users from the first search, the server can expand the search by performing a second search of a second geographic area including the point of interest at a second scale. The second scale is greater than the first scale such that the second geographic area is greater in size than the first geographic area. The server continues to expand until certain stopping conditions are met, e.g., a minimum number of users are grouped together. The matching process may be dynamic, with rules for the matching process dynamically changing as groups are formed. The matching process may further take into account other parameters, e.g., user profiles, geographical locations of the users, position in queue, etc.

The server provides 730 the shared virtual experience to the users of each group by generating tailored perspectives of the shared virtual experience to each user, the tailored perspective including shared content common to the group and player-specific content specific to each user. When providing the tailored perspective, the server renders the shared content with the player-specific content. In some embodiments, the player-specific content may include elements representing the geographical location of a user, which may also include virtual representations of points of interest in the user's vicinity. In some embodiments, the player-specific content may include rendering the content based on a time of day for the user, weather in the geographical region of the user, etc. The shared content is rendered in the perspectives across the users in the group, such that all users in the group perceive the shared experience, though tailored to each user's perspective with the player-specific content.

### Example Computing System

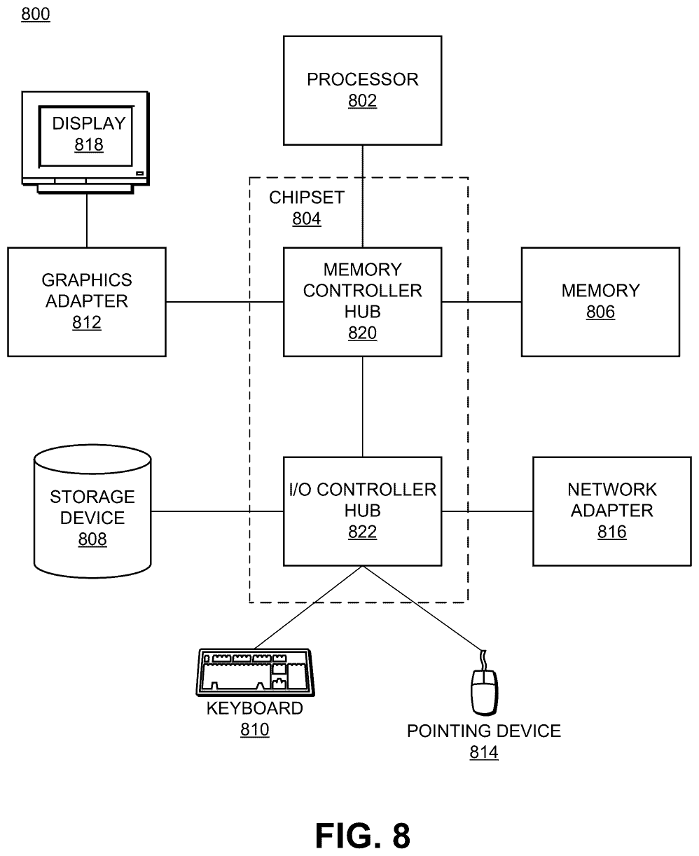

FIG. 8 is a block diagram of an example computer 800 suitable for use as a client device 310 or game server 320. The example computer 800 includes at least one processor 802 coupled to a chipset 804. References to a processor (or any other component of the computer 800) should be understood to refer to any one such component or combination of such components working cooperatively to provide the described functionality. The chipset 804 includes a memory controller hub 820 and an input/output (I/O) controller hub 822. A memory 806 and a graphics adapter 812 are coupled to the memory controller hub 820, and a display 818 is coupled to the graphics adapter 812. A storage device 808, keyboard 810, pointing device 814, and network adapter 816 are coupled to the I/O controller hub 822. Other embodiments of the computer 800 have different architectures.

In the embodiment shown in FIG. 8, the storage device 808 is a non-transitory computer-readable storage medium such as a hard drive, compact disk read-only memory (CD-ROM), DVD, or a solid-state memory device. The memory 806 holds instructions and data used by the processor 802. The pointing device 814 is a mouse, track ball, touchscreen, or other type of pointing device, and may be used in combination with the keyboard 810 (which may be an on-screen keyboard) to input data into the computer system 800. The graphics adapter 812 displays images and other information on the display 818. The network adapter 816 couples the computer system 800 to one or more computer networks, such as network 370.

The types of computers used by the entities of FIG. 3 can vary depending upon the embodiment and the processing power required by the entity. For example, the game server 320 might include multiple blade servers working together to provide the functionality described. Furthermore, the computers can lack some of the components described above, such as keyboards 810, graphics adapters 812, and displays 818.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate+/−10% unless another meaning is apparent from the context. For example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing the described functionality. Thus, while particular embodiments and applications have been illustrated and described, it is to be understood that the described subject matter is not limited to the precise construction and components disclosed. The scope of protection should be limited only by any claims that ultimately issue.

What is claimed is:

1. A computer-implemented method comprising:
receiving, from a first client device of a first user, a request to participate in a shared virtual experience, the request including an object identifier associated with initializing the shared virtual experience;
matching the first user to one or more other users to form a group based on the object identifier to participate in the shared virtual experience; and
providing the shared virtual experience to the first user and the one or more other users, comprising:
causing an electronic display of the first client device to display a tailored perspective of the shared virtual experience comprising shared content common to the group participating in the shared virtual experience and player-specific content specific to the first user.

2. The computer-implemented method of claim 1, wherein the object identifier identifies a point of interest, and wherein receiving the request from the first client device to participate in the shared virtual experience comprises determining that a geographical location of the first client device is within a threshold proximity to the point of interest.

3. The computer-implemented method of claim 2, wherein matching the first user to the one or more other users comprises:
performing a first search of a first geographic area including the point of interest at a first scale to identify users to match with the first user.

4. The computer-implemented method of claim 3, wherein matching the first user to the one or more other users further comprises:
matching the first user with at least one other user identified from the first search.

5. The computer-implemented method of claim 3, wherein matching the first user to the one or more other users further comprises:
responsive to the first search not identifying sufficient suitable users to match with the first user to form a minimum group size, performing a second search of a second geographic area including the point of interest at a second scale, the second geographic area greater in size than the first geographic area; and
matching the first user with at least one other user identified from the second search.

6. The computer-implemented method of claim 2, wherein the tailored perspective comprises a virtual representation of the point of interest as part of the player-specific content specific to the first user.

7. The computer-implemented method of claim 1, wherein the object identifier identifies a virtual object that is represented by a plurality of visual representations viewable by users at a plurality of real-world locations, and wherein receiving the request from the first client device to participate in the shared virtual experience comprises receiving, from the first client device, interaction with one visual representation of the virtual object.

8. The computer-implemented method of claim 7, wherein matching the first user to the one or more other users further comprises:
querying a list of users seeking a shared virtual experience using the object identifier;
selecting the one or more other users from the query results based on one or more parameters; and
creating a group including the first user and the one or more other users.

9. The computer-implemented method of claim 8, wherein selecting the one or more other users from the query results based on the one or more parameters comprises selecting the one or more other users from the query results based on profiles of the first user and the one or more other users.

10. The computer-implemented method of claim 8, wherein selecting the one or more other users from the query results based on the one or more parameters comprises selecting the one or more other users from the query results based on geographical locations of the first user and the one or more other users.

11. The computer-implemented method of claim 7, wherein the tailored perspective comprises display of the virtual object as part of the shared content across the group.

12. The computer-implemented method of claim 11, wherein the tailored perspective further comprises one or more virtual elements reflecting a geographical location of the first user in the real-world as part of the player-specific content.

13. A non-transitory computer-readable storage medium storing instructions that, when executed by a computer processor, cause the computer processor to perform operations comprising:
receiving, from a first client device of a first user, a request to participate in a shared virtual experience, the request including an object identifier associated with initializing the shared virtual experience;
matching the first user to one or more other users to from a group based on the object identifier to participate in the shared virtual experience; and
providing the shared virtual experience to the first user and the one or more other users, comprising:
causing an electronic display of the first client device to display a tailored perspective of the shared virtual experience comprising shared content common to the group participating in the shared virtual experience and player-specific content specific to the first user.

14. The non-transitory computer-readable storage medium of claim 13, wherein the object identifier identifies a point of interest, and wherein receiving the request from the first client device to participate in the shared virtual experience comprises determining that a geographical location of the first client device is within a threshold proximity to the point of interest.

15. The non-transitory computer-readable storage medium of claim 14, wherein matching the first user to the one or more other users comprises:
performing a first search of a first geographic area including the point of interest at a first scale to identify users to match with the first user.

16. The non-transitory computer-readable storage medium of claim 15, wherein matching the first user to the one or more other users further comprises:
matching the first user with at least one other user identified from the first search.

17. The non-transitory computer-readable storage medium of claim 15, wherein matching the first user to the one or more other users further comprises:
responsive to the first search not identifying sufficient suitable users to match with the first user to form a minimum group size, performing a second search of a second geographic area including the point of interest at a second scale, the second geographic area greater in size than the first geographic area; and
matching the first user with at least one other user identified from the second search.

18. The non-transitory computer-readable storage medium of claim 13, wherein the object identifier identifies a virtual object that is represented by a plurality of visual representations viewable by users at a plurality of real-world locations, and wherein receiving the request from the first client device to participate in the shared virtual experience comprises receiving, from the first client device, interaction with one visual representation of the virtual object.

19. The non-transitory computer-readable storage medium of claim 18, wherein matching the first user to the one or more other users further comprises:
querying a list of users seeking a shared virtual experience using the object identifier;
selecting the one or more other users from the query results based on one or more parameters; and
creating a group including the first user and the one or more other users.

20. A system comprising:
a computer processor; and
a non-transitory computer-readable storage medium storing instructions that, when executed by the computer processor, cause the computer processor to perform operations comprising:
receiving, from a first client device of a first user, a request to participate in a shared virtual experience, the request including an object identifier associated with initializing the shared virtual experience;
matching the first user to one or more other users to form a group based on the object identifier to participate in the shared virtual experience; and
providing the shared virtual experience to the first user and the one or more other users, comprising:
causing an electronic display of the first client device to display a tailored perspective of the shared virtual experience comprising shared content common to the group participating in the shared virtual experience and player-specific content specific to the first user.
